(19) United States
(12) Patent Application Publication
(10) Pub. No.: US 2015/0180946 A1
(43) Pub. Date: Jun. 25, 2015

(54) Interactive System

(71) Applicant: CM Online Limited, Westcliff-on-Sea (GB)

(72) Inventors: Simon Daniel Mellamphy, Leigh-on-Sea (GB); Victor Michael Askew, Shoeburyness (GB); Terry Lee Turner, Leigh-on-Sea (GB); Bill Ferrett, Westcliff-on-Sea (GB)

(73) Assignee: CM Online LlIMITED, Westcliff-on-Sea (GB)

(21) Appl. No.: 14/411,427

(22) PCT Filed: Jun. 26, 2013
(86) PCT No.: PCT/GB2013/000281

§ 371 Date: Dec. 26, 2014

(30) Foreign Application Priority Data
Jun. 26, 2012 (GB) 1211353.6

(51) Int. Cl. H04L 29/08; G06F 3/0484

(52) U.S. Cl. CPC H04L 67/10; G06F 3/0484

(57) ABSTRACT

A system comprising: means for transmitting a webpage to a remote terminal, the webpage including code for presenting at the terminal interactive forms including user-selectable options, rules defining actions to be performed in response to user selections, and one or more links to video content. The webpage is configured to launch a first video clip at the terminal, to automatically display a first interactive form upon termination of said video clip, and to present one or more subsequent forms or video clips dependent on the selected option. Data indicative of each selected option is fed back to a remote location. One or more of the video clips or pages can be personalised. Pages and video clips can also be optimised dependent on capabilities of the remote terminal.

### FIELD OF THE INVENTION

This invention relates to a system and method for providing interactive content to remote terminals, particularly but not exclusively mobile terminals.

### BACKGROUND OF THE INVENTION

It is known to request information or feedback from users or customers electronically using an interactive system, e.g. a webpage.

In the context of mobile terminals, e.g. cellular telephones, PDAs, tablet computers, etc. interaction can be difficult as the user will usually have to zoom-in to read the webpage and then either type-in their responses and/or select options using touch-screen interaction. The interaction then results in data being sent back over a communications network and, usually, a new webpage is uploaded requesting further information and so on.

Another method of interaction is by means of sending and receiving a series of SMS messages. For example, a first SMS message may ask if a recipient was satisfied with a service or product, and to indicate their response with a YES or NO reply. Dependent on what the recipient sends back, a subsequent message may then be sent using a further SMS message, for example to indicate their level of satisfaction from “1” to “5”.

These methods are cumbersome and require multiple back and forth messages which may incur a fee each time a message is sent and/or use excessive bandwidth.

In situations where users or customers cannot read well, or have limited understanding of the language in which the requesting message is sent, such known methods have obvious disadvantages.

### SUMMARY OF THE INVENTION

A first aspect of the invention provides a system comprising: a memory storing an executable file for sending to a remote terminal, which file provides: one or more interactive pages which when presented on a display of the terminal displays a plurality of user-selectable options; a set of interaction rules each defining a respective action to be performed at the terminal in response to user-selection of one of the options; means for sending back to a predefined remote location data indicative of the user-selection(s); and means for sending or causing to be sent the file to a remote terminal.

Thus, an interaction file can be provided as a single file for execution on a user computing device, e.g. a mobile terminal.

The file can be a HTML webpage, e.g. incorporating a script such as Javascript. In this context, execution means the webpage is presented in a browser. The interactive pages can be forms, e.g. HTML forms, requiring user input, a page presenting selectable radio buttons or indeed any other type of page with displayable entities that a user can click or otherwise select.

The rules define an action to be performed in response to a user interacting with the current interactive page, which may be to launch another interactive page which is dependent on the particular interaction received. As will be introduced below, a video may be launched between interactive pages.

Thus, by providing the pages and rules, interaction is made possible without the need to retrieve and upload numerous web pages or send and receive numerous SMS messages.

The system may further comprise means for sending an initial link to the remote terminal which when activated at said terminal causes an activation message to be returned to the system, responsive to which the sending means sends or causes the file to be sent to the terminal. The link can be delivered in an email, SMS or WAP push message.

The system may further comprise means to identify the remote terminal from information received in the activation message and to store data indicative of the or each user interaction in association with the remote terminal identity. Thus, the system can keep track of user responses for various purposes by storing interaction information in association with the identity of the user/terminal that activated the message.

The file may further provides means for displaying an initial video clip on the remote terminal prior to display of an initial interactive page and for automatically presenting the initial interactive page upon termination of the initial video clip.

It will be appreciated that video clips provide a particularly rich and intuitive way to deliver a message to a user, customer or potential customer. It may be that the video clip is used to deliver a greeting, which may or may not be personalised, and to introduce the initial interaction page and what it is asking for in terms of feedback. Thus, for people who cannot read well, or who better understand the relevant language when spoken as opposed to written down, the video clip offers advantages. Indeed, the video clip in its content may refer to particular features of the interaction page to assist the user, e.g. by informing them that YES can be selected using the green button on the next page and NO by selecting the red button.

The means for displaying the initial video clip may comprise a link to a remote location storing said clip which is arranged to be automatically activated at the terminal after receipt of the file. The video clips may be stored within memory of the system, or elsewhere. What the video file contains is a link to allow the videos to be accessed over a network.

One or more of the interaction rules may identify different video clips for display on the terminal dependent on the user selection(s) using the interactive pages, the identified video clip being displayed automatically after user selection. One or more of the interaction rules may identify a subsequent interactive page to be displayed on the terminal automatically after termination of a video clip, which subsequent interactive page is dependent on the user selection(s) on the or each previously-displayed interactive page(s). The interaction rules may identify the different video clips by means of respective links to a remote location storing said clips, the links being automatically activated after user selection.

The system may further comprise a video personalisation module for creating at least one of said video clips, the video personalisation module comprising selection means enabling a user to select from a first database a first video file which refers in its content to a name or entity and from a second database a second video file which refers in its content to a message or greeting, the video personalisation module being arranged to generate the video clip by joining the first and second video files.

So, for example, the initial video clip may refer to a particular user's name or a particular group of people in an organisation. The personalisation may be present in more than one clip, or a clip other than the initial clip. The video files may be joined by the video personalisation module in response to activation of a link corresponding to the video clip at the remote terminal.

The system may further comprise means arranged to detect a predetermined user-selection made at the remote terminal and in response thereto to provide one or more new pages and/or rules and/or links to videos which are dependent on the user-selection and to send said new pages/rules/links to the terminal for augmenting or replacing existing content at the terminal.

The system may further comprise means to identify the display capabilities of the remote terminal from information received from the terminal and to send the or each interactive page and/or video clip in a format appropriate to the identified display capabilities. The identifying means may perform the identifying and sending operations each time data is requested from the remote terminal.

The means to identify display capabilities may be configured to receive header information identifying the recipient device type and/or a display browser of the device and to interrogate a database indicating a format appropriate to said device and/or browser.

A second aspect of the invention provides a system comprising: means for transmitting a webpage to a remote terminal, the webpage including code for presenting at the terminal interactive forms including user-selectable options, rules defining actions to be performed in response to user selections, and one or more links to video content, wherein the webpage is configured to launch a first video clip at the terminal, to automatically display a first interactive form upon termination of said video clip, to automatically present one or more subsequent forms or video clips dependent on the selected option, and to feed back data indicative of each selected option to a remote location.

The system may further comprise means to identify the display capabilities of the remote terminal from information received in an activation message and to send the or each interactive page and/or video clip in a format appropriate to the identified display capabilities. The means to identify display capabilities is preferably configured to receive header information identifying the recipient device type and/or a display browser of the device and to interrogate a database indicating a format appropriate to said device and/or browser. The system may further comprise means to generate one or more of the interactive forms with personalised content. The system may further comprise means to generate one or more of the video clips with personalised content, said personalisation means being configured to receive selection of a first video which refers in its content to a name or entity, selection of a second video which refers in its content to a message or greeting, and to generate a concatenated video clip comprising the joined first and second videos.

The system may further comprise means to generate or provide a new set of rules and/or forms and/or video links in response to a received interaction, the new set of rules being sent to the terminal and replacing the existing set.

The personalisation means may generate the concatenated video clip in response to activation of the corresponding link at the remote terminal.

A third aspect of the invention provides a method comprising: providing one or more files, the or each file, when executed by a data processing means being configured: to display one or more interactive pages each having a plurality of user-selectable options; and to apply a set of interaction rules, each defining a respective action to be performed in response to user-selection of one of the options; sending, or causing to be sent, to a remote terminal the or each file for execution; and receiving from the remote terminal data indicative of the user selection(s).

The method may further comprise, prior to the step of sending the file, sending an initial link to the remote terminal which when activated at said terminal causes an activation message to be returned to the system, receiving the activation message, and responsive to receiving said activation message, sending or causing to be sent the file to the terminal.

The method may further comprise identifying the remote terminal from information received in the activation message and storing data indicative of the or each user interaction in association with the remote terminal identity.

The file, when executed, may further provide means for displaying an initial video clip on the remote terminal prior to display of an initial interactive page and for automatically presenting the initial interactive page upon termination of the initial video clip.

The file may comprise a link to a remote location storing said initial video clip which is automatically activated at the terminal after receipt of the file.

One or more of the interaction rules may identify different video clips for display on the terminal dependent on the user selection(s) using the interactive pages, the identified video clip being displayed automatically after user selection.

One or more of the interaction rules may identify a subsequent interactive page to be displayed on the terminal automatically after termination of a video clip, which subsequent interactive page is dependent on the user selection(s) on the or each previously-displayed interactive page(s).

The interaction rules may identify the different video clips by means of respective links to a remote location storing said clips, the links being automatically activated after user selection.

The method may further comprise receiving selection of a first video file which refers in its content to a name or entity and of a second video file which refers in its content to a message or greeting, and generating a personalised video clip by joining the first and second video files for sending to the terminal.

The video files may be joined in response to activation of a link corresponding to the joined video clip at the remote terminal.

The method may further comprise detecting a predetermined user-selection made at the remote terminal and in response thereto providing one or more new pages and/or rules and/or links to videos which are dependent on the user-selection and to send new pages/rules/links to the terminal for augmenting or replacing existing content at the terminal.

The method may further comprise identifying the display capabilities of the remote terminal from information received from the terminal and sending the or each interactive page and/or video clip in a format appropriate to the identified display capabilities. The identifying and sending steps may be performed each time data is requested from the remote terminal.

The identifying step may comprise receiving header information identifying the recipient device type and/or a display browser of the device and interrogating a database indicating a format appropriate to said device and/or browser.

The initial link may be sent to the remote terminal in an email, SMS or WAP push message.

A fourth aspect of the invention provides a method comprising: sending a webpage to a remote terminal, the webpage including code for presenting at the terminal interactive forms including user-selectable options, rules defining actions to be performed in response to user selections, and one or more links to video content, wherein the webpage is configured to launch a first video clip at the terminal, to automatically display a first interactive form upon termination of said video clip, to automatically present one or more subsequent forms or video clips dependent on the selected option, and to feed back data indicative of each selected option to a remote location.

The method may further comprise identifying the display capabilities of the remote terminal from information received in an activation message and sending the or each interactive page and/or video clip in a format appropriate to the identified display capabilities.

The step of identifying the display capabilities may comprise receiving header information identifying the recipient device type and/or a display browser of the device and interrogating a database indicating a format appropriate to said device and/or browser.

The method may further comprise generating one or more of the interactive forms with personalised content.

The method may further comprise generating one or more of the video clips with personalised content, by means of receiving selection of a first video which refers in its content to a name or entity, receiving selection of a second video which refers in its content to a message or greeting, and generating a concatenated video clip comprising the joined first and second videos.

The concatenated video clip may be generated in response to activation of the corresponding link at the remote terminal.

A fifth aspect of the invention provides a method comprising: receiving and executing a file from a remote server, the file when executed being configured to display one or more interactive pages each having a plurality of user-selectable options, and to apply a set of interaction rules, each defining a respective action to be performed in response to user-selection of one of the options; and sending, or causing to be sent, to a remote terminal data indicative of the user selection(s).

A sixth aspect provides a method comprising: at a first computer, sending a webpage to a remote terminal, the webpage including code for presenting at the terminal interactive forms including user-selectable options, rules defining actions to be performed in response to user selections, and one or more links to video content; at a second, remote terminal, receiving the webpage, and automatically: launching a first video clip, displaying a first interactive form upon termination of said video clip, presenting one or more subsequent forms or video clips dependent on the selected option, and feeding back data indicative of each selected option to the first computer or an associated computer.

A seventh aspect of the invention provides a computer program comprising instructions that when executed by computer apparatus control it to perform method steps as defined above.

An eighth aspect of the invention provides a non-transitory computer-readable storage medium having stored thereon computer-readable code, which, when executed by computing apparatus, causes the computing apparatus to perform a method comprising: displaying one or more interactive pages each having a plurality of user-selectable options, and to apply a set of interaction rules, each defining a respective action to be performed in response to user-selection of one of the options; and sending, or causing to be sent, to a remote terminal data indicative of the user selection(s).

### BRIEF DESCRIPTION OF THE DRAWINGS

The invention will now be described by way of non-limiting example with reference to the accompanying drawings, in which:

FIG. 1 is a block diagram showing a typical communications network over which interactive campaigns can be created and sent to user terminals;

FIG. 2 is a block diagram of components of an interactive video platform (IPV) of the system shown in FIG. 1;

FIG. 3 is a schematic diagram showing different types of data present in an interactive campaign file, e.g. a HTML and JavaScript webpage;

FIG. 4 is a flow diagram illustrating processing steps performed at the IPV and the user terminal in the stages of sending interactive content, its execution, and stages of receiving requested video content in accordance with a first embodiment;

FIG. 5 is a schematic diagram of a set of rules provided by the IPV;

FIG. 6 shows schematic views of the output presented at a user terminal when running the interactive content;

FIG. 7 is a flow diagram illustrating processing steps performed at the IPV and the user terminal in the stages of sending interactive content, its execution, and stages of receiving requested video content in accordance with a second embodiment; and

FIG. 8 is a flow diagram illustrating the steps in detecting display capabilities of a user device and tailoring a video clip for that device.

### DETAILED DESCRIPTION OF PREFERRED EMBODIMENTS

Embodiments herein provide systems and methods for sending to mobile terminals interactive content, including interactive pages for receiving user interactions, rules for determining subsequent steps dependent on the interactions, and for receiving information pertaining to user interactions. The embodiments are also applicable to non-mobile terminals, but particular advantages are found with mobile terminals.

Further, embodiments herein provide as part of the interactive content links to one or more video clips, which are retrieved from the system and played on the mobile terminal. The video clips (other than the initial one) will be dependent on previous interactions in order that the message makes sense and is appropriate to previous user inputs. In this regard, it is considered more intuitive and personal to prompt user feedback with a video clip, rather than a purely textual page or form, for example by indicating the various options in the audio track associated with the video clip. In this way, people who cannot read well can also engage in the interaction and feedback process. The embodiments have particular application in less-developed countries where levels of literacy are low but the use of technology is high.

In some embodiments, personalisation is introduced. One or more of the interactive pages can be personalised to include the name of individuals or groups of individuals or indeed any identifiable entity. Additionally, or alternatively, personalised video clips can be used by joining two clips together, one which refers to a selected name or entity and another which is a more generic message. The resulting concatenated message appears personal in nature and is therefore more engaging. Preferably, the concatenated content is generated ‘on the fly’ that is when the recipient of the interactive content (or rather the rules of the content) activates the link to the video. This reduces the need to store many versions of joined content that may be needed for different combinations; rather, only when the video is to be viewed is it joined and then sent, e.g. by streaming.

In some embodiments, the display capabilities of the intended users device are determined and used to send the video clip in a format appropriate to the capabilities, e.g. based on device type, device name, browser type. This can be done by interrogating a database which indicates which format/layout to use.

The above personalisation uses systems and methods described in the Applicant's co-pending International Patent Publication No. WO2011/124880, the entire contents of which are incorporated herein by reference.

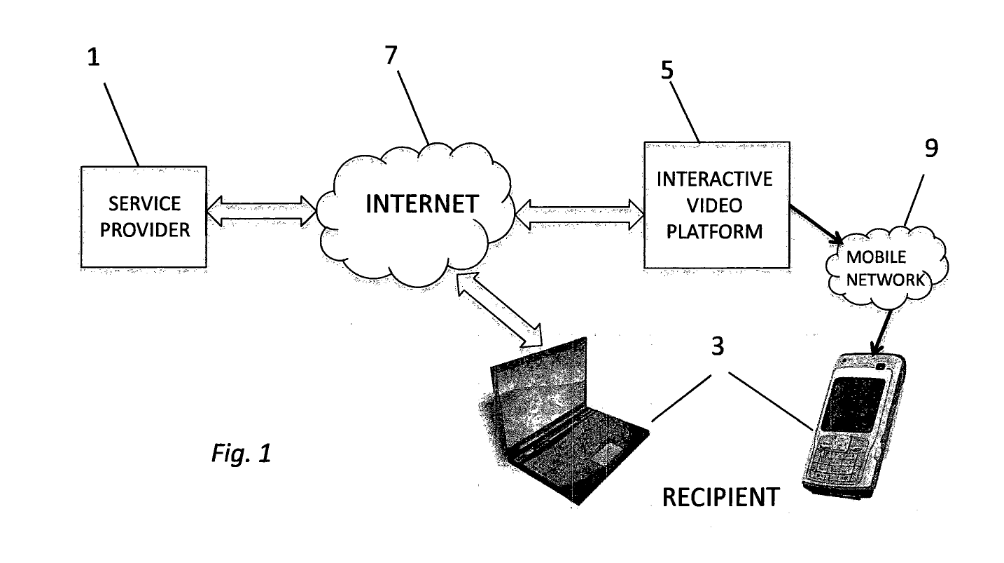

Referring to FIG. 1, there is shown a network arrangement in which a service provider 1 can use an interactive video platform (IVP) 5 for the purpose of generating a campaign for requesting information and/or feedback from user entities such as users of the providers service and/or potential users.

The IVP 5 stores the data necessary for generating the interactive video campaign, which it sends to users' mobile terminals 3 for execution, display and retrieval of interactive feedback data. The data can be transferred using any communications network, e.g. IEEE 802.11 (WiFi), GSM, CDMA, UMTS, Bluetooth. The more typical networks of the Internet 7 and a mobile network 9 are shown as examples.

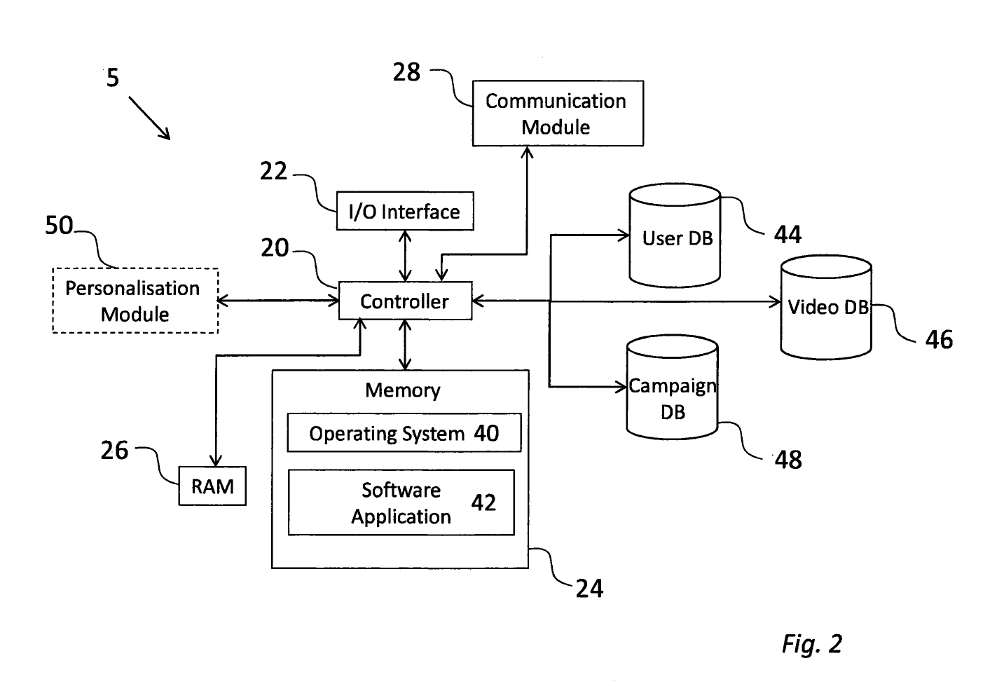

FIG. 2 shows a schematic diagram of the components of the IVP 5. The IVP 5 has a controller 20, an input and output interface 22 which can be of any form, e.g. keyboard and display, a memory 24, RAM 26, and a wireless communication module 28. The wireless communications module 28 may be configured to communicate via several protocols such as GSM, CDMA, UMTS, Bluetooth and IEEE 802.11 (Wi-Fi).

The memory 24 may be a non-volatile memory such as read only memory (ROM) a hard disk drive (HDD) or a solid state drive (SSD). The memory 24 stores, amongst other things, an operating system 40 and may store software applications 42. The RAM 26 is used by the controller 20 for the temporary storage of data. The operating system 40 may contain code which, when executed by the controller 20 in conjunction with RAM 26, controls operation of each of the hardware components of the terminal.

The controller 20 may take any suitable form. For instance, it may be a microcontroller, plural microcontrollers, a processor, or plural processors.

The IVP 5 may be a dedicated server provided at the premises of the service provider 1 for their personal use, or may be provided by an interaction service provider, as in this example, for use by subscribing users as a third party service. The IVP 5 through its software application 42 prompts user input or the uploading of certain data in order to create and store data pertaining to a campaign of the service provider 1.

Still referring to FIG. 2, also connected to the controller 20 is a user database 44, a video database 46 and a campaign database 48. The user database 44 is arranged to store, for the service provider 1, a list of contact information for one or more users, including email addresses and/or mobile telephone numbers. The video database 46 stores video files (which can be in any streaming format) for use in the service providers campaign. The campaign database 48 stores one or more pages in the form of HTML forms to form part of the service providers campaign, and is also used to store interaction data received as a result of user interactions.

A personalisation module (PM) 50 is also shown connected to the controller 20. The purpose and functionality of this module will be described later on.

In using the IVP 5, the service provider 1 will upload to the databases 44, 46, 48 the above-mentioned information. This is done by accessing the software application 42 which provides a graphical user interface (GUI) taking the service provider 1 through the various steps involved in sending the appropriate information to the appropriate database 44, 46, 48.

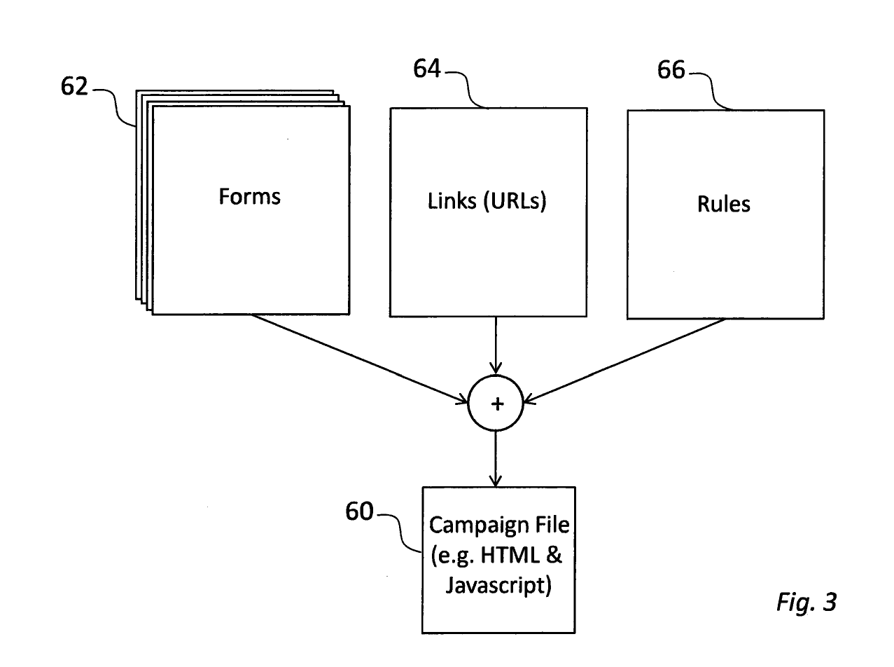

When the service provider 1 wishes to launch their interactive service, the IVP 5 is configured to generate the campaign. Referring to FIG. 3, in its simplest form, the IVP 5 generates a webpage 60 comprising HTML and Javascript code that specifies:
One or more forms 62;
One or more links (URLs) 64 to the videos in the video database 46;
A set of rules 66 to determine actions to be taken in response to any user input.

A form 62 can be an HTML form or it can be one or more entities with which the user can interact, e.g. using a mouse click or a touch-screen gesture on their terminal.

The webpage 60 is sent to one or more users as specified in the user database 44.

This is initiated by sending a link (by email, SMS or WAP push) to the user, activation of which causes the webpage to be created, then sent and launched on their terminal.

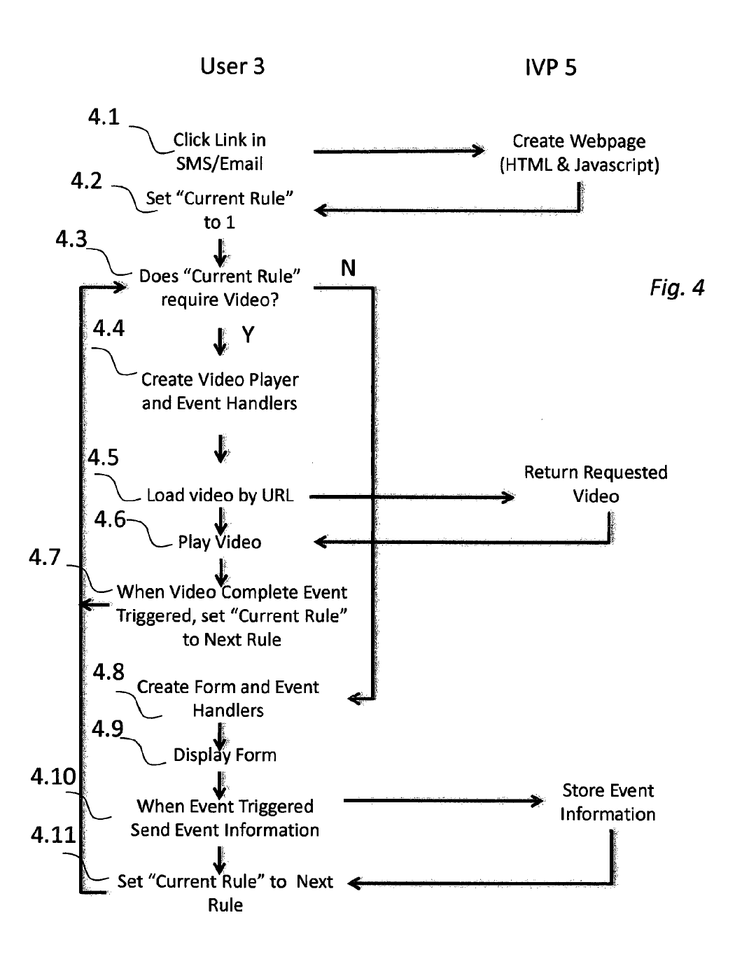

FIG. 4 shows the operating steps of the webpage 60 when running on a user terminal, e.g. the smart phone 3 in FIG. 1.

In a first step 4.1, the user clicks the link sent by the IVP 5. This causes an activation message to be sent back to the IVP 5 which generates the webpage and sends it back to the user terminal 3. In step 4.2, the webpage 60 sets the current rule to RULE 1 which will have an associated action and set of event handlers.

In step 4.3 it is determined whether RULE 1 requires video. If yes, then in step 4.4 a video player is created and launched on the smart phone 3 and event handlers set up in accordance with the current rule. In step 4.5 the video specified in RULE 1 is requested from the server 5 by means of a URL link and in step 4.6 the video is output. In step 4.7, at the end of the video, the event handlers trigger RULE 1 to be replaced with a different rule, e.g. RULE 2. The process then returns to step 4.3.

If at step 4.3, the current rule does not require video, then it will specify an interactive form, and hence in step 4.8 the form is created and the associated event handlers set up. In step 4.9 the form is displayed on the smart phone 3. The form will include one or more interaction options, e.g. a form to be filled-in, buttons to be clicked or selected using hand gestures, radio buttons and indeed any form of interactive display. In step 4.10 when an event is triggered (e.g. an interaction event) then event information is sent to the IVP 5 for storage thereat. In step 4.11, the current rule is set to the next rule, dependent on the user interactions. The process then returns to step 4.3 and continues until a rule is reached which terminates the operation.

The rules may define, in effect, a hierarchy of pages and/video clips the levels of which are traversed depending on previous user interactions.

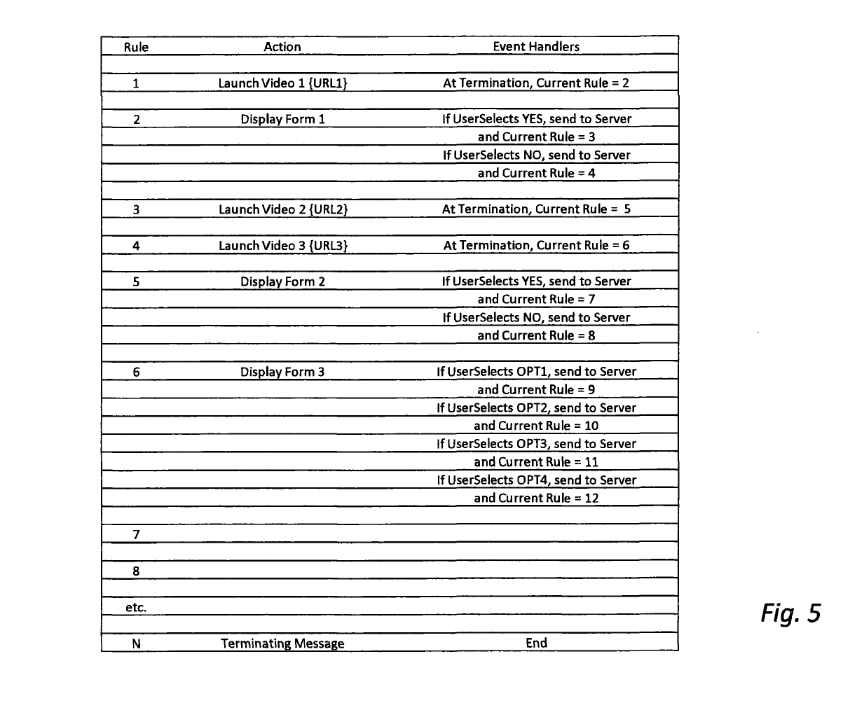

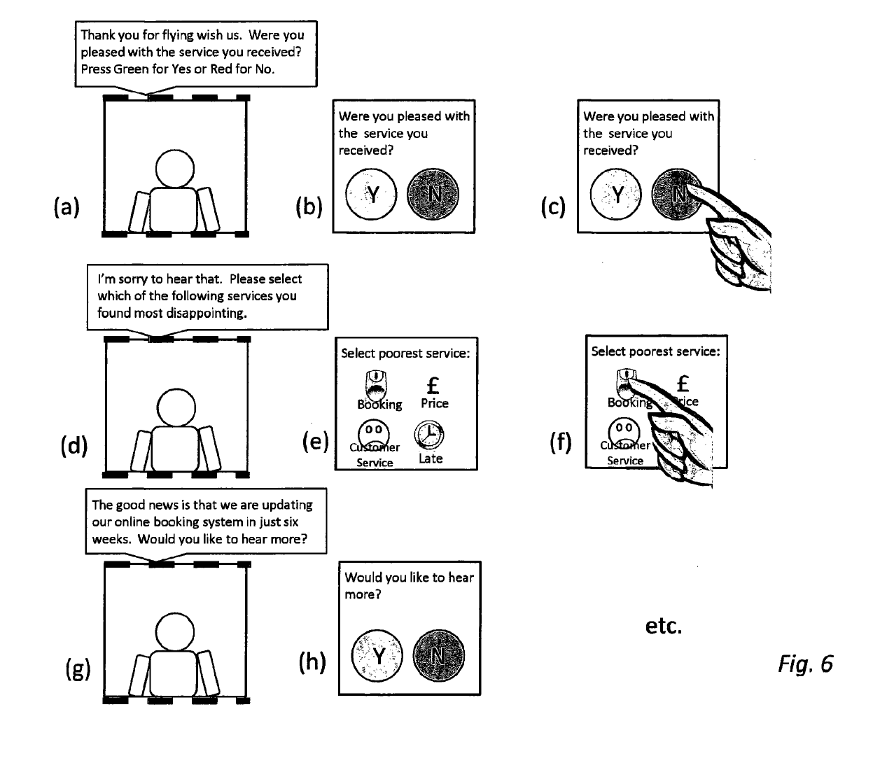

Referring to FIG. 5, a very simple set of rules 66 is shown for a campaign. For ease of explanation, we assume that the campaign relates to that of an airline wishing to obtain customer feedback from passengers who have flown with them in the past seven days. FIGS. 6(a) to 6(h) depict example graphical output at different stages of the interaction process, which is useful for understanding the process.

Initially, the IVP 5 sends an email or SMS link to each of the passengers identified as having flown, indicated in the user database 44.

When a user activates their link, the IVP 5 sends the webpage to the user's terminal. This activation generates a message which is sent to the IVP 5 allowing it to identify from whom any subsequent interaction data is coming from, and to store that data against that user in the campaign database 48.

The current rule is RULE 1 and so (as indicated in FIG. 5) VIDEO1 is automatically retrieved from the video database 46 using URL1 and starts playing on a video player. VIDEO1 may comprise a clip delivered by a senior member of the airline thanking them for using the airline recently and asking them whether or not they were pleased with the service they received. The person may then ask that the user indicate either YES or NO in the following page; alternative labels can be used, e.g. green button or a tick symbol for YES and a red button or cross symbol for NO, which is useful for people with limited reading ability. FIG. 6(a) shows an example of VIDEO1 output.

When the video clip completes, or terminates, the current rule becomes RULE 2, as indicated in FIG. 5.

In repeating the process, RULE 2 causes FORM1 to be displayed, as shown in FIG. 6(b). FORM1 in this case repeats the basic question delivered in the video using text, and provides the YES and NO interactive options. If the user clicks YES, then the event handlers determine that this YES response is sent back to the IVP 5 and also that the current rule becomes RULE 3. If the user clicks NO, then the event handlers determine that this NO response is sent to the IVP 5 and that the current rule becomes RULE 4.

If we take the case where the user selects NO from FORM1, as shown in FIG. 6(c), then the current rule becomes RULE 4. This causes retrieval of a new video clip (VIDEO3) using URL3 from the IVP 5 which starts playing on the smart phone 3. This is shown in FIG. 6(d). This video will be appropriate to the interaction, and so may depict the airline member expressing regret that the user was not pleased and inviting them to indicate specifically why they are dissatisfied. At termination of VIDEO3, the current rule becomes RULE 6. Rule 6 causes a new interaction FORM3 to be displayed which allows the user to indicate why they were not satisfied, e.g. by displaying selectable buttons for:
OPT1=Online Booking System Difficult;
OPT2=Price of Ticket Too High;
OPT3=Check-In Staff Unhelpful or Rude;
OPT4=Late Departure;

FIG. 6(e) shows this example. It follows that selecting one of the buttons (e.g. as shown in FIG. 6(f)) causes corresponding interaction data to be sent to the IVP 5 and for the next rule to be applied. The next rule may, for example, cause presentation of a video specific to the complaint, e.g. a video of the airline member explaining what steps are being taken to improve the online booking system (see FIG. 6(g)), which, when finished presents a form asking if the user would like further information in an email (see FIG. 6(h)).

It should be clear from the structure of the rules shown in FIG. 5 that a hierarchy of interactive forms and videos present to users a meaningful series of messages and interaction options which are dependent on previous selections. The final rule N terminates the process.

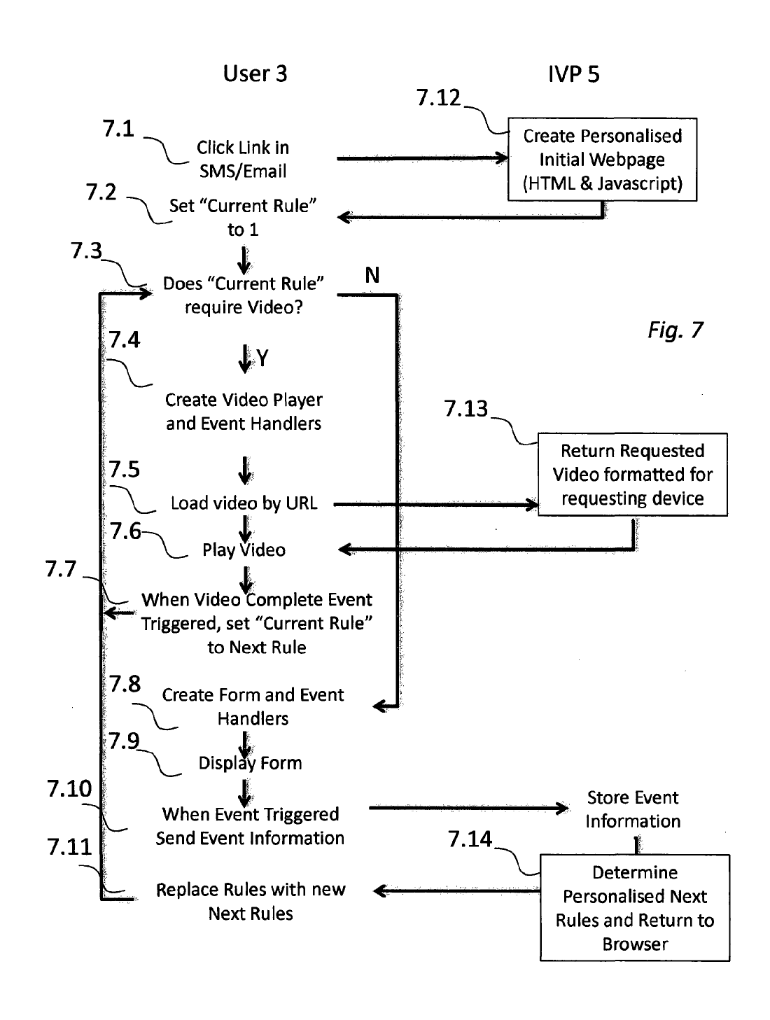

Referring to FIG. 7, the operating steps of providing the webpage 60 in a second embodiment are shown. This process is more advanced in that it provides for one or more personalisation operations performed at the IVP 5, these operations being indicated in bounded boxes with reference numerals 7.12, 7.13 and 7.14. Note that the order of reference numerals is not indicative of processing order. Steps 7.1 to 7.10 are largely similar to steps 4.1 to 4.10.

One form of personalisation is in relation to the initial page, form and/or video clip. In step 7.12 the IPV 5 uses the identity information returned in the link activation to personalise the initial page, form or clip to the user, e.g. using his or her name displayed on the page or referred to in the video clip, if the initial presentation includes video. The creation of personalised video clips by joining two or more separate clips to form concatenated content is discussed further below. In this case, a link is generated which references the clips to be joined at the IVP 5. Whatever the form of personalisation, the personalised page, form or clip is preferably generated only once the relevant link is activated to save on memory storage at the IPV 5; otherwise the IPV would have to store multiple versions of the same page, form or clip, i.e. one for each entity name.

Where a personalised video clip is not the initial message corresponding to RULE1, the joined clip is generated when the corresponding link in the set of rules is activated automatically following the previous interaction.

Another form of personalisation is to send pages, forms and/or clips in a format or layout that is appropriate to the user's device or browser. This occurs in step 7.13, which uses information received from the user terminal 3 when the link is activated in step 7.1, e.g. in header information identifying the user's device type and/or browser. In this respect, it will be appreciated that there are many different types of potential recipient receiving device, including computers and mobile terminal, as listed previously, each of which may use a different operating system, browser with various video decoding and playback capabilities. By detecting the capabilities in step 7.1 that at that time the pages, forms and/or clips can be converted into a format suitable for the device.

Thus, step 7.13 involves generating a video clip suitably formatted and/or encoded for the device/browser detected from step 7.1. If clips are already available in the required format, these may be sent.

Referring to step 7.14, based on one or more interactions that have so far been received, a new rule table can be generated at the IVP 5. These are then sent back to the terminal 3 and replace the existing set, either wholly or partially, before the process returns to step 7.1.

To give one example, the initial form might be in a default language (e.g. English) and permit interaction in the form of allowing the user to select an alternative language from a list. If preceded by a video, the video clip may for example give an introductory message in several languages. If the user in step 7.10 selects a language other than the default, then in step 7.14 a set of replacement forms and/or links to videos and/or rules may be generated and sent back to the user terminal. In step 7.11 they replace, to the extent that is necessary, the current forms/links/rules. The main HTML and Javascript remains the same, but the underlying forms/links/rules may be replaced either wholly or partially. The process then returns to step 7.3 as before.

So, if the user selects, say, “French”, then in step 7.14 the IVP 5 might change the forms to ones given in French, and links to videos delivered in the French language. The rule logic (i.e. the logic that determines which rules follows the current one) may remain the same. In some embodiments however, the rule logic may also be updated to change which rule is subsequent to the current one. The order of forms/videos thus presented to French speakers may differ from that presented to the default English forms/videos.

The choice of default language might be selected based on information received from the user terminal 3, e.g. based on its country of registration or the network. Nevertheless, the above personalisation process enables other languages to be provided for.

Other uses for such on-the-fly personalisation may be envisaged.

### Creating Personalised Video Clips

The PM 50 uses information, e.g. provided by the service provider 1, to generate, store and incorporate a personalised video message into the interactive web page. The personalised video message can be the initial message or indeed any of the video clips. In brief, two or more clips are selected to be joined together, and the identity of the clip is stored against the users identity as a job number. A link to the job number is stored in a set of personalised rules. When the rules are present at the user terminal 3, and the link activated, the video request is sent to the PM 50 which at that point creates the joined video ‘on the fly’ and delivers it to the user terminal 3 in the usual way.

One of the clips may refer to the user's name and the other may have a more generic greeting. For example, as in the airline example, “Hello Dan . . . thank you for flying with us last week. Were you satisfied with our performance?”

### Delivering Video Clips According to Device Capabilities (Step 7.13)

In the case of mobile telephones, tablet computers and PDAs, it will be appreciated that the user device 3 (and the software running on it) is not initially known to the IVP 5; all that is known is the recipient's mobile telephone number or email address. Different mobile telephones and PDAs have different capabilities and can use a number of different browsers which may be unsuited to decoding a particular codec, or may show it in a non-optimal manner.

The embodiment described with reference to FIG. 7 therefore provides a form and video delivery process (VDP) 7.13 for converting video clips to a format appropriate to a particular receiving device at the time the delivered message is opened or activated by the recipient.

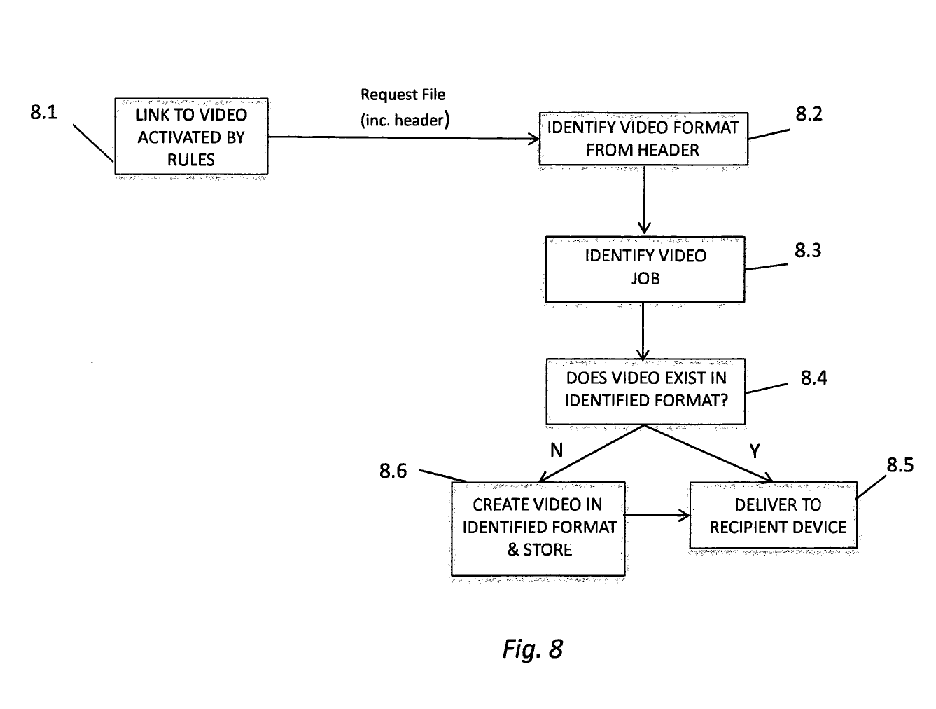

In the refined system, described here with reference to FIG. 8, a so-called Receiving Device Identifier Program (RDIP) is provided as part of the IVP 5; the role of the RDIP is to use a database of mobile device capabilities to identify the requesting device 3, and more particularly its video playing capabilities, at the time the link to the video is activated by the rules in the interactive content. Having identified the requesting device and its capabilities, an appropriate format, in this case a 3GP format, is identified and a check is performed to see if there is already stored at the IVP 5 the video combination in the identified 3GP format. If so, it can be delivered; if not, it is generated at the IVP and then delivered.

Although 3GP is used in this example, other formats can be used if this is the requirement of the requesting mobile device. Examples include 3GP (for general phones), MP4/H264 (for iPhones/Android), AVI (to view on Blackberrys), and FLV (For PC's).

Referring to FIG. 10, in a first step 10.1, the user terminal 3 activates the link to the video. This corresponds to step 7.5 in FIG. 7. The request contains ‘header’ information which identifies the device agent (indicating the device and browser). In step 10.2, the request is passed to a RDIP ‘controller’ which uses a MediaFormat class to identify the appropriate delivery format for the device agent. This is a 3-stage process:
a. a device database is interrogated to build the fall back tree of devices (the concept of fall back trees is discussed below);
b. a media format database table is interrogated to find the active formats that match the fall back tree of devices; and
c. the active format that relates to the most specialised device in the fallback tree is selected.

In step 10.3, the recipient's request is used to identify the contents of the personalised video, i.e. the two or more separate clips to be joined, usually identified against a job number. In step 10.4, a check is performed to identify whether a video with the required clips in the selected active format exists. If it does, then in step 10.5 it can be delivered to the device. If it does not exist then in step 10.6, the clips are joined and created and delivered in the required format. The concatenated video clip can also be stored for later use, e.g. in case a further request is received for the particular message combination in the particular format.

It will be appreciated that identifying the requesting device and creating the video are two separate processes. Generally, the requesting device, and therefore the format to be delivered, can only be identified at the time of the request. The latest point at which the video can be created is after identification and immediately before delivery. This is the default; there is nothing to prevent a video of specific content and format being created at any time before a request is received, however. The challenge is to balance the cost of the resources required to pre-create and store all possible combinations of content and format that could be requested against the delay incurred when a non-existent video has to be created at the time of the request.

In terms of whether a video file can be created before a request is received based on the telephone number specified by the ‘giver’ of the message, it will be appreciated that a telephone number does not define the capabilities of the device used to request a video. In fact, a smart phone could have a choice of software and the requestor could repeat the same request using a different browser (requiring a different video format) for each request.

In practice, one could envisage a few situations where pre-creation would be practicable. Firstly, a corporate campaign for staff where the requesting devices are known, e.g. all staff use Blackberry phones. Also, a corporate campaign for external customers where the device agent of each customer's mobile has already been identified and stored in a customer/recipient database (assuming each had to register using their phone at some point in the past). This might still require a ‘dynamic create’ where customers change their phone but keep their number and do not ‘re-register’ but after a single request the new device agent could be stored for future reference.

There will now be described in greater detail the above identification and video generating steps of the RDIP with specific reference to the device database fall back trees.

To recap, the objectives of the VDP and RDIP may be summarised:
1. To use the device database to identify requesting devices.
2. to automatically select the appropriate video format for the requesting device.
3. to store the parameters required to create the chosen format in a database.
4. to define a structure for data (videos, logs, etc.) folders.

### Identifying the Requesting Device

The RDIP library structure. includes amongst other things:
a database of device capabilities that can be interrogated by “user agent”
PHP classes to interrogate the database;

It is important to appreciate the concept of the ‘fall back tree’ of devices. This is a hierarchical tree with the most generic set of capabilities at the root which becomes more specific as one moves up the tree. Each set of capabilities has an identifying ‘device’ string. For example, the fall back tree for a Blackberry 8800 is:
blackberry8800_ver1
blackberry_generic_ver4_sub20
blackberry_generic_ver4_sub10
blackberry_generic_ver4
blackberry_generic_ver3_sub70
blackberry_generic_ver3_sub60
blackberry_generic_ver3_sub50
blackberry_generic_ver3_sub30
blackberry_generic_ver2
blackberry_generic
generic_xhtml
generic

The received HTTP request contains a “user agent” string. The “user agent” is used to identify all applicable entries in the device database in the form of a fallback tree. The entries in the tree are matched against a database of media formats returning the least generic.

The media format contains all the necessary information to generate a video in the optimal format for the requesting device including the transport protocol e.g. “pseudo-streaming”, RTSP, HTTP streaming, etc.

### Creating the Video File

A class called CM_Resource_Video is responsible for creating and retrieving video files. The class focuses on the name and message requirements of the PVS 5 providing 2 main functions:
create($name, $message, $mediaFormat, $watermark=false)
createMessage($message, $mediaFormat, $watermark=false)

In both cases, the class adopts the following approach:
1. construct the necessary path, filename and extension and check if the file exists;
2. if it does then return ‘success’;
3. if it doesn't, check if the source video files exist;
4. if they do then convert them to the required format using the parameters returned by the MediaFormat class and return.

For create( ), if the concatenated source video does not exist, the source name and message files are spliced together to create a personalised video in ‘base’ format then this file is converted to the required ‘delivery’ format. Currently, the ‘base’ video format is ‘mpg’ as this allows for concatenation of the component videos.

The paths and some filenames related to video management are retrieved from the app.ini configuration file.

Assuming the CM_Resource_Video class returns ‘success’, the calling class can then proceed knowing the video file exists in the required delivery format.

### Locations of Video Files

As already stated, the paths and some filenames (e.g. watermark images) are retrieved from the app.ini file.

Typically, the video process folders are grouped together. The configuration file allows for the following separate folders:
names source (′base′ format) name clips, e.g. kara_adam.mpg;
messages source (′base′ format) message clips, e.g. kara_email_for_you.mpg. Also, message clips in preview formats, e.g. kara_email_for_you.fiv;
personal spliced videos (in ‘base’ format), e.g. kara_adam_kara_email_for_you.mpg, and in ‘delivery’ formats, e.g. kara_adam_kara_email_for_you.3gp;
trailers source (‘base’ format) clips to be spliced at the end of messages;
watermarks images (‘gif’ or ‘png’) used to overlay on videos.

### Maintenance Aspects of the Process

### Review the Media Format Devices and Parameters

It is likely with the development of video processing software that media formats will be able to be optimised or formats for a different video processor could be created.

### Maintaining the State of the Device Database

The device database requires maintenance in respect of corrections and improvements to existing data and the addition of data for new devices.

Human intervention is required to identify if new Media Format instances are required to be generated.

### Administration Pages to Maintain the Media Format Table

Administration pages exist to help test device recognition, create and update media format records and test media formats.

### The Balance Between Disk Resource and ‘Time-to-Deliver’

As indicated above, all the unique combinations of a video (performer, name, message and format), once requested and created, are retained to provide the quickest response. The more combinations, the more disk space required.

In some situations this can mitigated quite simply: e.g. once a corporate campaign has ended, all videos for that particular message could be deleted or archived—automatically or manually.

Normally, the type of the requesting device is not known until the request for the video is received (although this may not be the case in some corporate scenarios). In an ideal world, all combinations of delivery format videos will be pre-created and able to be delivered ‘on demand’.

In the event that this approach is constrained by some factor (disk space, processor resource or time to create) then it is desirable to identify the combinations that will be the most popular and focus resources on those. It is anticipated that ‘most popular’ could be defined by any combination of performer, name, message or format and that the prediction of popularity will be improved by the analysis of previous deliveries.

In some embodiments, the process of tailoring the form or video format to suit the recipient device takes place at each connection/retrieval and not necessarily just when the user clicks on the link in step 7.1. Rather, in addition to detecting capabilities at step 7.1, the above RDIP module can be arranged to detect the capabilities each time a video is requested from the IVP 5 (step 7.13) and/or personalised updates are provided in step 7.14. Thus, within a single message retrieval, if the recipient should change network connection mid-stream, plug-in a bigger screen, or even change to a different type of terminal mid-stream, the RDIP module can detect the change and optimise accordingly. That is, we can perform device recognition and format tailoring at the time each video is retrieved and not just at the beginning of an interactive message session.

There is no ‘run-time library’ or specific configuration needed on the destination devices for this implementation. We do not need to know which device the client will connect with beforehand. Each connection/retrieval is treated as a separate event and will receive a separate, tailored format, determined based on the capabilities of the device they connect with at that time.

In summary, there has been described a method and apparatus for providing interactive video, particularly, though not exclusively, on a mobile device. When playing a video clip on a mobile device, such as a smartphone, what is usually presented is a full screen video which plays from start to end. There is little or no provision for interacting with the video to control what happens next.

It would be advantageous to provide a method and apparatus for providing interactive video, particularly for use on mobile devices such as mobile telephones, smartphones, PDAs, tablets and so on.

An interactive video (IV) platform provides the ability to deliver a webpage to an internet browser the content of which combines video and user interface controls in order to capture a user's responses and communicate that information to a server computer.

The IV platform can combine with other components to deliver a webpage customised both in terms of content (related to the requesting user) and format (related to the requesting user's device—e.g. type of smartphone, desktop computer, etc.).

In a simple form, the IV platform delivers a webpage containing HTML and JavaScript code that specifies: one or more forms; one or more links to videos; a set of rules to determine the action to be taken in response to any user input event.

In this context, a ‘form’ could be an HTML form or just one or more entities with which the user can interact, e.g. by a mouse click or touch input. Based on the first rule, the embodied logic determines the initial state of the webpage to be displayed. The initial state could be a ‘form’ or a video player. If a form is displayed, the webpage responds to user actions by retrieving the appropriate rule and determining the next state of the webpage, i.e. the next form to be displayed or video to be played. If a video is to be played then an associated ‘next rule’ is stored and that rule is invoked when the video ends. As each rule is processed, the web server is notified of the action taken by the user. The server responds with a success or error status.

In a more advanced implementation, using existing components employed by the Applicant in their co-pending patent application no. PCT/GB2011/000525 the contents of which are incorporated herein by reference, it is possible to dynamically modify the webpage delivered to the user's browser in a number of ways.

For example if a personalised link is sent to the user, e.g. by email or SMS, then the resulting request can be used to generate personalised video clips, i.e. referring to the user by name and/or a set of ‘forms’, videos and rules customised to the particular user.

Additionally or alternatively, the make/model and features of the requesting device can be automatically identified and the content to be delivered can be customised to match those features, e.g. video format, page layout, etc.

As each rule is processed, the web server is notified of the action taken by the user. The server responds with a success or error status. In more complex implementations, the server can respond with additional information that can be used to modify the flow of content and user action.

When the interactive webpage is delivered to the browser, it can be uniquely identified by the inclusion of a character string(s) generated by the server computer. In addition, if the webpage was requested using a personalised link then the webpage can be directly associated with the user to whom that link was sent.

On each user interaction, the page communicates to the server the details of the webpage identifier and the user action which is then stored in a database for later retrieval and analysis.

By providing for user interaction within an internet browser with video, subsequent actions, including the playing of particular video clips, can be controlled and useful interaction data collected by the server. The presentation of interaction entities on, e.g. a smartphone, can be tailored so as to enable understanding and interaction by people with knowledge of different languages or little or no understanding of written language. For example, if a series of interaction rules define different actions resulting from YES or NO inputs, the displayed interaction entities corresponding to YES and NO can simply be green and red icons, respectively.

It will be appreciated that the above described embodiments are purely illustrative and are not limiting on the scope of the invention. Other variations and modifications will be apparent to persons skilled in the art upon reading the present application.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. A system comprising:
a memory storing an executable file for sending to a remote terminal, which file provides:
one or more interactive pages which when presented on a display of the terminal displays a plurality of user-selectable options;
a set of interaction rules each defining a respective action to be performed at the terminal in response to user-selection of one of the options;
means for sending back to a predefined remote location data indicative of the user-selection(s); and
means for sending or causing to be sent the file to a remote terminal.

2. A system according to claim 1, further comprising means for sending an initial link to the remote terminal which when activated at said terminal causes an activation message to be returned to the system, responsive to which the sending means sends or causes the file to be sent to the terminal.

3. A system according to claim 2, further comprising means to identify the remote terminal from information received in the activation message and to store data indicative of the or each user interaction in association with the remote terminal identity.

4. A system according to claim 1, wherein the file further provides means for displaying an initial video clip on the remote terminal prior to display of an initial interactive page and for automatically presenting the initial interactive page upon termination of the initial video clip.

5. A system according to claim 4, wherein the means for displaying the initial video clip comprises a link to a remote location storing said clip which is arranged to be automatically activated at the terminal after receipt of the file.

6. A system according to claim 1, wherein one or more of the interaction rules identify different video clips for display on the terminal dependent on the user selection(s) using the interactive pages, the identified video clip being displayed automatically after user selection.

7. A system according to claim 6, wherein one or more of the interaction rules identify a subsequent interactive page to be displayed on the terminal automatically after termination of a video clip, which subsequent interactive page is dependent on the user selection(s) on the or each previously-displayed interactive page(s).

8. A system according to claim 6, wherein the interaction rules identify the different video clips by means of respective links to a remote location storing said clips, the links being automatically activated after user selection.

9. A system according to claim 4, further comprising a video personalisation module for creating at least one of said video clips, the video personalisation module comprising selection means enabling a user to select from a first database a first video file which refers in its content to a name or entity and from a second database a second video file which refers in its content to a message or greeting, the video personalisation module being arranged to generate the video clip by joining the first and second video files.

10. A system according to claim 9, wherein the video files are joined by the video personalisation module in response to activation of a link corresponding to the video clip at the remote terminal.

11. A system according to claim 1, further comprising means arranged to detect a predetermined user-selection made at the remote terminal and in response thereto to provide one or more new pages and/or rules and/or links to videos which are dependent on the user-selection and to send said new pages/rules/links to the terminal for augmenting or replacing existing content at the terminal.

12. A system according to claim 2, further comprising means to identify the display capabilities of the remote terminal from information received from the terminal and to send the or each interactive page and/or video clip in a format appropriate to the identified display capabilities.

13. A system according to claim 12, wherein the identifying means performs the identifying and sending operations each time data is requested from the remote terminal.

14. A system according to claim 12, wherein the means to identify display capabilities is configured to receive header information identifying the recipient device type and/or a display browser of the device and to interrogate a database indicating a format appropriate to said device and/or browser.

15. A system according to claim 2, wherein the initial link is sent to the remote terminal in an email, SMS or WAP push message.

16. A system comprising:
means for transmitting a webpage to a remote terminal, the webpage including code for presenting at the terminal interactive forms including user-selectable options, rules defining actions to be performed in response to user selections, and one or more links to video content, wherein the webpage is configured to launch a first video clip at the terminal, to automatically display a first interactive form upon termination of said video clip, to automatically present one or more subsequent forms or video clips dependent on the selected option, and to feed back data indicative of each selected option to a remote location.

17. A system according to claim 16, further comprising means to identify the display capabilities of the remote terminal from information received in an activation message and to send the or each interactive page and/or video clip in a format appropriate to the identified display capabilities.

18. A system according to claim 17, wherein the means to identify display capabilities is configured to receive header information identifying the recipient device type and/or a display browser of the device and to interrogate a database indicating a format appropriate to said device and/or browser.

19-46. (canceled)

47. A method comprising:
at a first computer, sending a webpage to a remote terminal, the webpage including code for presenting at the terminal interactive forms including user-selectable options, rules defining actions to be performed in response to user selections, and one or more links to video content; and
at a second, remote terminal, receiving the webpage, and automatically:
launching a first video clip,
displaying a first interactive form upon termination of said video clip,
presenting one or more subsequent forms or video clips dependent on the selected option, and
feeding back data indicative of each selected option to the first computer or an associated computer.
